(19) United States
(12) Patent Application Publication
(10) Pub. No.: US 2015/0118999 A1
(43) Pub. Date: Apr. 30, 2015

(54) Systems and Methods for Creating and Managing Mobile Phone Services

(71) Applicant: UVA MOBILE, INC., San Diego, CA (US)

(72) Inventor: Mehul Merchant, San Diego, CA (US)

(21) Appl. No.: 14/522,547

(22) Filed: Oct. 23, 2014

Related U.S. Application Data
(60) Provisional application No. 61/896,045, filed on Oct. 26, 2013.
(60) Provisional application No. 61/905,738, filed on Nov. 18, 2013.
(60) Provisional application No. 61/939,682, filed on Feb. 13, 2014.

(51) Int. Cl. H04W 8/18; H04W 4/24; H04W 12/08

(52) U.S. Cl. CPC H04W 8/186; H04W 12/08; H04W 4/24
USPC 455/411; 455/414.1

(57) ABSTRACT

Methods, systems, means and machine-readable media embodying program instructions for creating a customized mobile plan are described. The customized mobile plan may include different services that are divided among multiple subscribers, and may be tailored to match preferences or behavior of different subscribers. Historical usage profiles may be analyzed to determine expected usage needs of various subscribers over time.

### FIELD

This disclosure relates generally to one or more systems, methods, computer program products, and means for controlling customized mobile plans for different subscribers.

### BACKGROUND

Subscribers of mobile phone, text and data services face various pain points regarding purchase and use of phone, text and data plans (often referred to as “mobile plans”). Operators of these mobile plans (“mobile operators”) tend to offer bundled services that do not fit the unique needs of individual subscribers. These “one size fits all” bundles impact a subscriber's ability to maximize his or her budget in view of the subscriber's desired use of services. For example, two subscribers may have the same budget, but may prefer different services such that the same bundle may disadvantage a first user who prefers data over the other services (where the first user prefers to allocate more budget to data services), while also disadvantage a second user who uses a phone service more than the other services (where the second user would prefer to allocate more to phone services).

To make matters worse, mobile operators lack functionality that allows a subscriber to dynamically allocate services before and during a usage period. The static approach by which mobile operators offer services impact a subscriber's ability to adapt to his or her current needs based on past use and projected use that may vary over from. When a group of subscribers share the same mobile plan, mobile operators do not permit an administrator of that mobile plan to allocate the service amounts to particular subscribers, or to set service amounts for one subscriber at preferred levels while allocating remaining amounts to remaining subscribers based on a fixed budget (where the allocations of the remaining amounts may not be preferred, but may be necessary given budget constraints).

Fortunately, this disclosure describes various systems, methods and machine-readable media for customizing and controlling mobile services offered to and used by subscribers that overcome the weaknesses described above.

### SUMMARY

Certain embodiments of this disclosure relate to systems (e.g., networks, devices, and device components), methods and machine-readable media for customizing and controlling mobile services to a group of users. Such systems, methods and machine-readable media may: generate, using one more processors, an allocation of services for a group of subscribers that specifies an amount of time units for a phone call service, an amount of messages for a text messaging service, and an amount of data for a data service; generate, using the one more processors, a respective allocation of the services for each of the subscribers that specifies respective portions of the amount of the time units, the amount of the messages, and the amount of the data for that subscriber; receive data that specifies a modification to (1) the amount of time units, (2) the amount of messages, (3) the amount of data, or (4) a first portion of a first one of the services allocated to a first subscriber; identify one or more locked statuses indicating whether one or more of the following can be adjusted: (1) a payment amount set by one of the subscribers, (2) the amount of time units, (3) the amount of messages, (4) the amount of data, (5) the first portion; and (6) a second portion of a second one of the services allocated to the first subscriber, or of the first one of the services allocated to a second subscriber; and generate, based on the modification and the one or more locked statuses, one or more adjustments to one or more of (1) the payment amount, (2) the amount of time units, (3) the amount of messages, (4) the amount of data, (5) the first portion, and (6) the second portion. The details of the above and other embodiments are set forth in the accompanying drawings and the description below. Other features, objects, and advantages of the invention will be apparent from the description and drawings, and from the claims.

### BRIEF DESCRIPTION OF THE DRAWINGS

The present application may be more fully appreciated in connection with the following detailed description taken in conjunction with the accompanying drawings:

FIG. 1 shows a block diagram depicting a system for creating and administering service plans for mobile devices.

FIG. 2 illustrates a process flow relating to creation and administration of service plans for mobile devices.

FIG. 3 depicts a user interface for setting up a service plan for multiple subscribers.

FIG. 4A depicts a user interface for creating, viewing and modifying a service plan for multiple subscribers.

FIG. 4B depicts another user interface for creating, viewing and modifying a service plan for multiple subscribers.

FIG. 5A depicts a user interface for modifying a service plan for a subscriber.

FIG. 5B depicts another user interface for modifying a service plan for a subscriber.

FIG. 6 depicts a user interface for allocating usage of data based on speed.

FIG. 7 depicts a user interface for modifying an amount of a service.

FIG. 8A depicts a user interface for defining time periods during which use parameters control a subscriber's use of services.

FIG. 8B depicts another user interface for defining time periods during which use parameters control a subscriber's use of services.

FIG. 9 illustrates a process flow relating to automatic adjustments to one or more service amounts based on modifications to another service amount.

FIG. 10 illustrates a process flow relating to control of user access to particular services under various circumstances.

FIG. 11 illustrates a process flow for establishing a service plan for subscribers.

FIG. 12 depicts a user interface associated with a computer application for selecting a first option that restricts access to one or more services or a second option that increases amounts of one or more services

FIG. 13 depicts a user interface relating to the first option of FIG. 12.

FIG. 14 depicts a user interface relating to the second option of FIG. 12.

FIG. 15 depicts a user interface for setting a number of users (or lines), a budget and types of services.

FIG. 16 depicts a user interface for identifying user types, setting numbers users (or lines) per user type, and setting a budget per user type.

FIG. 17 depicts a user interface for designating equal shares of services among users, or setting unequal portions of services among users.

FIG. 18 depicts a user interface for setting portions of services among different users.

FIG. 19 depicts information provided to users under certain embodiments.

FIG. 20 depicts information provided to users under certain embodiments.

FIG. 21 depicts information provided to users under certain embodiments.

FIG. 22 shows a block diagram depicting a device at which various device components reside for carrying out different aspects of different embodiments.

### DETAILED DESCRIPTION

Various aspects of the disclosure are described below. It should be apparent that the teachings herein may be embodied in a wide variety of forms, and that any specific structure and/or function disclosed herein is merely representative.

This disclosure relates generally to one or more systems, methods, and computer program products for creating a customized, mobile plan that is tailored to match preferences, historical usage profile, and/or expected usage needs of various subscribers (e.g., a family, a company or other group of subscribers). The plan may be controlled by price, as well as services provided like talk (i.e., phone), data or text. An administrator of the plan (e.g., a parent, a group manager) may make modifications during a use period that can reallocate resources or restrict use. Additional details are provided in the examples below.

### Example Systems

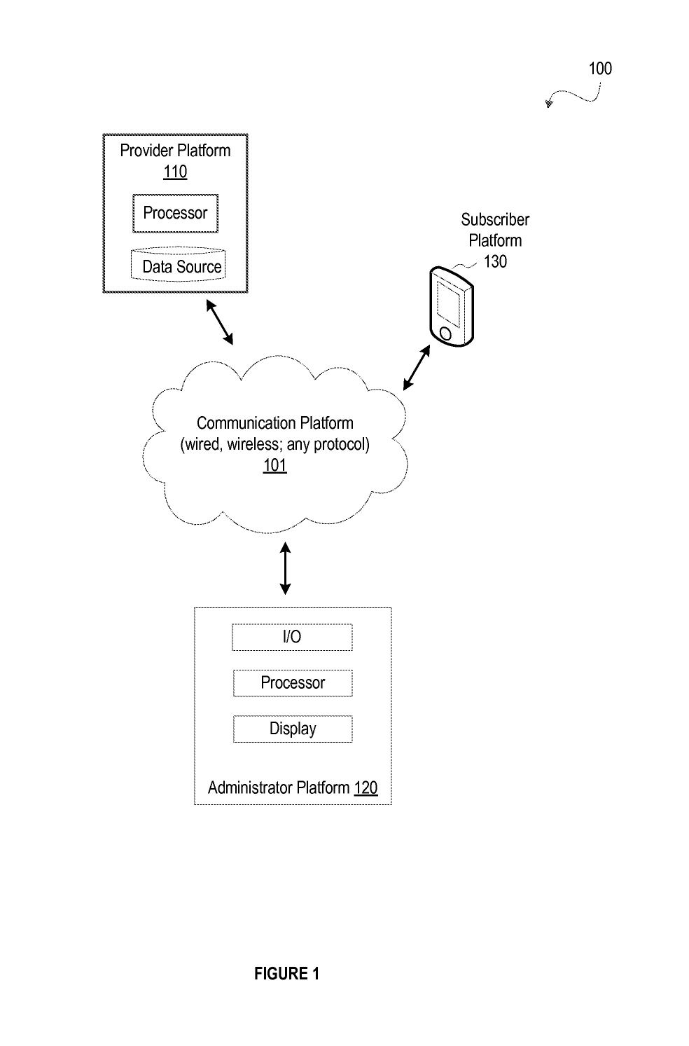

FIG. 1 depicts certain aspects of the disclosure relating to a system 100 for administering the selection and delivery of mobile services to various subscribers (or “users”) on mobile devices. Such “mobile services” may include talk, text, and data services that are provided in the United States and elsewhere internationally.

The system 100 may include various platforms, including a communication platform 101, a provider platform 110, an administrator platform 120, and a subscriber platform 130. The term “platform” as used herein may refer to a single device or device component, or a grouping of devices or device components at the same location or different locations. A platform may include components or devices that may be hosted by parties other than those directly associated with the labeling of each platform. Each platform may include hardware, software, firmware or other components that receive, process, store and send data. Each platform also may include any suitable computing device that is configured to allow an operator of that platform to view information and input selections, including any of numerous general purpose or special purpose computing systems like personal computers, hand-held or laptop devices, mobile phones, tablets, e-readers, touch-screen computing devices, and programmable consumer electronics. The platforms may use various software applications, including those that operate in conjunction with a web browser through a local area network connection or radio link, and those that operate without web connectivity.

In some embodiments, the provider platform 110, administrator platform 120 and subscriber platform 130

each may include various components, including those depicted in FIG. 22, which includes input/output interface(s) 2201 (e.g., keyboard, touch screen, speaker, microphone, or any other interface), network interface(s) 2202 (e.g., wired and wireless means like radio antennas, USB ports, or any other transceiving hardware), temporary or long term memory 2203, processor(s) 2204, and data source(s) 2205 that include one or more storage devices. The platforms may further include a software solution stored in the memory 2203, where the processor 2204 executes instructions embodied in the software solution to implement any of the operations disclosed herein. Certain aspects of each platform are described in more detail below. It is to be understood that the description herein is not intended to be limiting, and alternative embodiments are contemplated as understood by one of skill.

### Communication Platform 101

The communication platform 101 utilizes any known or later-developed communication technologies to facilitate communication among the various other platforms. Examples of communication technologies include any known or later-developed wired and/or wireless communication pathways, protocols and infrastructure.

### Provider Platform 110

The provider platform 110 may be configured to control access to mobile services by other platforms (e.g., subscriber platforms 130). Such platforms may reside at a network operator that provides and controls mobile services to users. Such network operators may include server(s), transmitter(s), data source(s) and other devices needed to provide services to subscribers.

### Administrator Platform 120

The administrator platform 120 may be configured to allocate a fixed amount of each mobile service to particular subscribers during a service period (e.g., per month, per week, per day, per time of day). The administrator platform 120 may further modify which mobile services are available to particular subscribers as circumstances change during the service period. The administrator platform 120 may be operated by an administrator associated with a group of users who share amounts of talk, text and data services. The administrator may or may not be a member of the group.

### Subscriber Platform 130

The subscriber platform 130 may be configured to initiate or receive talk, text and data services. Such platforms 130 may include mobile computing devices like smart phones, PDAs, tablets, laptops, and other mobile computing devices. The subscriber platform 130 may be operated by subscribers who use the talk, text and/or data services via their individual subscriber platforms 130.

The above systems, or portions thereof (e.g., processors), may implement various methods that are described below.

### Example Methodologies

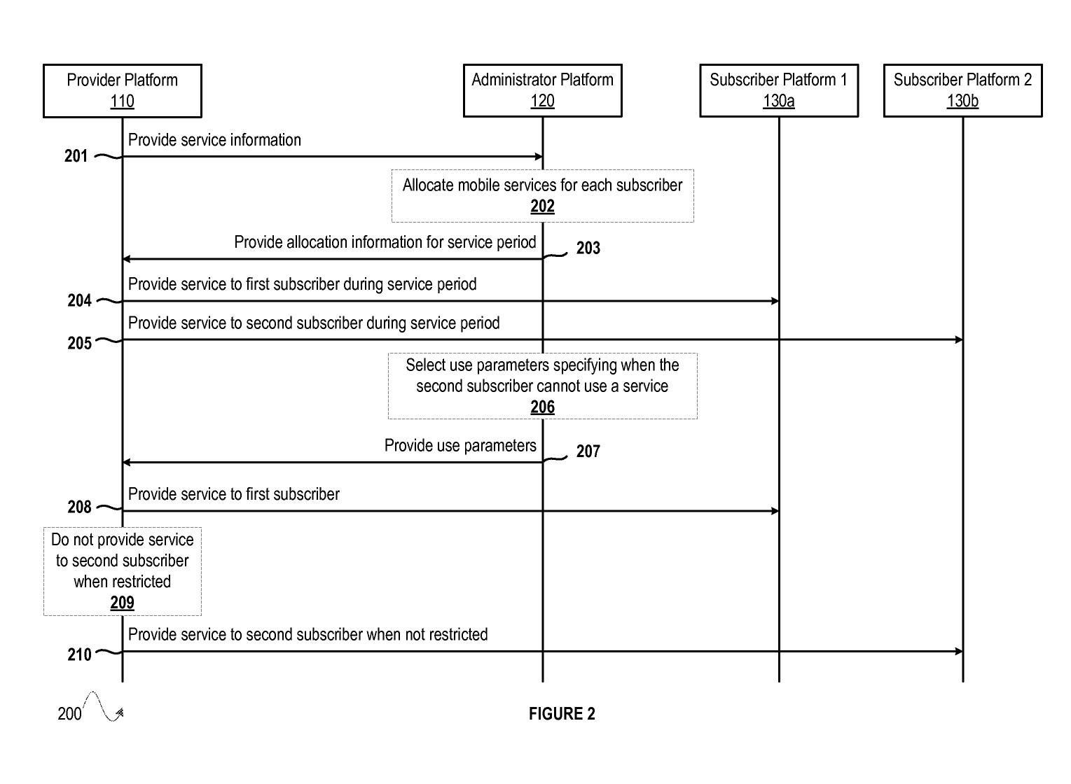

Attention is now drawn to FIG. 2, which depicts a high-level process flow 200 for allocating services among subscribers and for controlling access to those services by those subscribers.

As shown in FIG. 2, the provider platform 110 provides service information to the administrator platform 120 (201). The service information may include types of services (e.g., talk, text, and data), amounts of those services that can be purchased, cost of those services, and other information. The service information may be displayed to an administrator operating the administrator platform 120.

The administrator may select a total amount of each service based on a budget, and then allocate different amounts of each service to different subscribers (202). Additional detail regarding how services are allocated by the administrator is provided elsewhere herein in relation to other figures.

The administrator platform 120 provides the allocation information to the provider platform 110 (203), which uses it to provide services to different subscribers, including a first subscriber (204) and a second subscriber (205).

An administrator may select use parameters that specify when a subscriber cannot use a particular service (206). For example, the administrator selects use parameters for a second subscriber. The use parameters are provided to the provider platform 110 (207).

Services are provided to the first subscriber (208). The provider platform 110 does not provide services to the second subscriber based on the use parameters (209) until the use parameters allow the second subscriber to access previously restricted services (210).

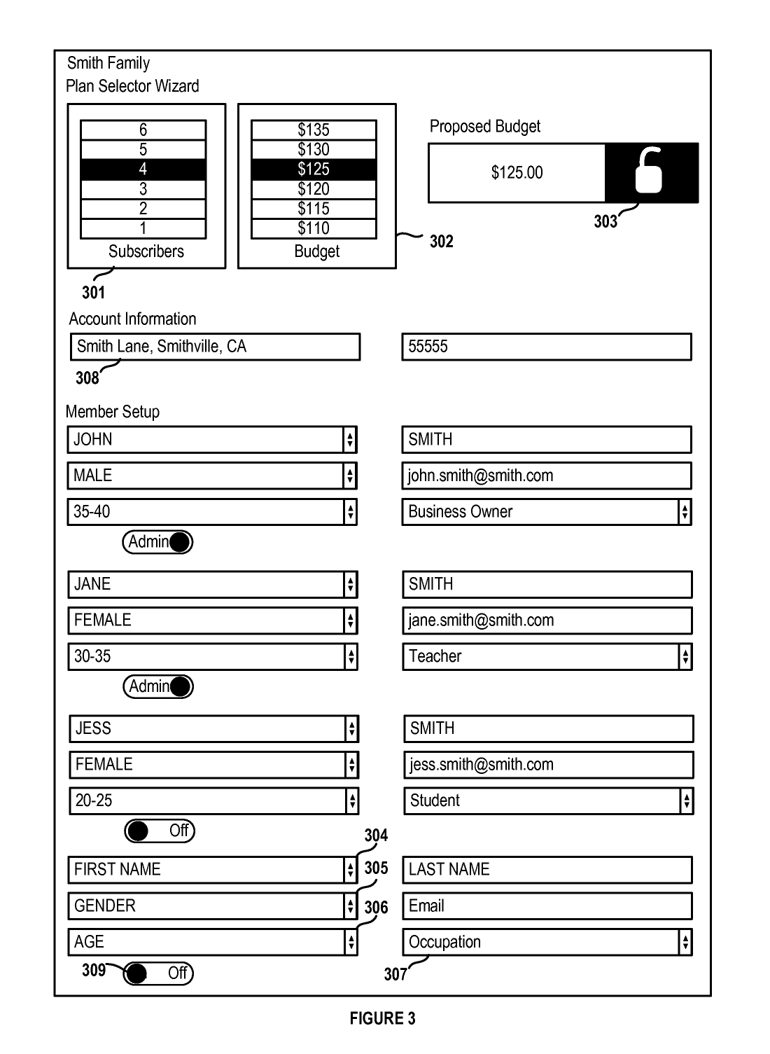

Attention is now drawn to FIGS. 3-6, which depict user interfaces that provide service information to the administrator, and that further receive input from the administrator. Such input may control allocation of services to groups of subscribers and individual subscribers.

### Identification of Initial Parameters

As shown in FIG. 3, a user interface enables an administrator to create a mobile service plan for any number of subscribers. As shown, the administrator selects a number of subscribers (301), selects a budget (302), and further has an option to lock the budget (303). In FIG. 3, four subscribers are selected, and a budget is set at $125. The budget is not locked.

The administrator may further interact with the user interface of FIG. 3 to input information about each subscriber/member. For example, the administrator may input each subscriber's name (304), gender (305), age (306), and occupation (307). The administrator may also input account information (308) that specifies a location (309). In FIG. 3, a location in a California is provided, and subscriber information is provided (e.g., a 35-40 year old male business owner, a 30-35 year old female teacher, a 20-25 year old female student). Other subscriber information is contemplated, including organization-specific information (e.g., a subscriber's rank or position; needs; calendar of scheduled events in a service period like travel schedule, sales meetings, and other events; historical use like daily, weekly, monthly, annually, and other periods of use; and other information). As discussed in further detail below, the information about each subscriber and the location may be used to determine default allocations of total talk, text and data service amounts for the group of subscribers and/or talk, text and data for individual subscribers. The default amounts may also be based on the budget. Admin privileges (310) may also be allocated for each subscriber. Such privileges determine which subscriber can act as an administrator.

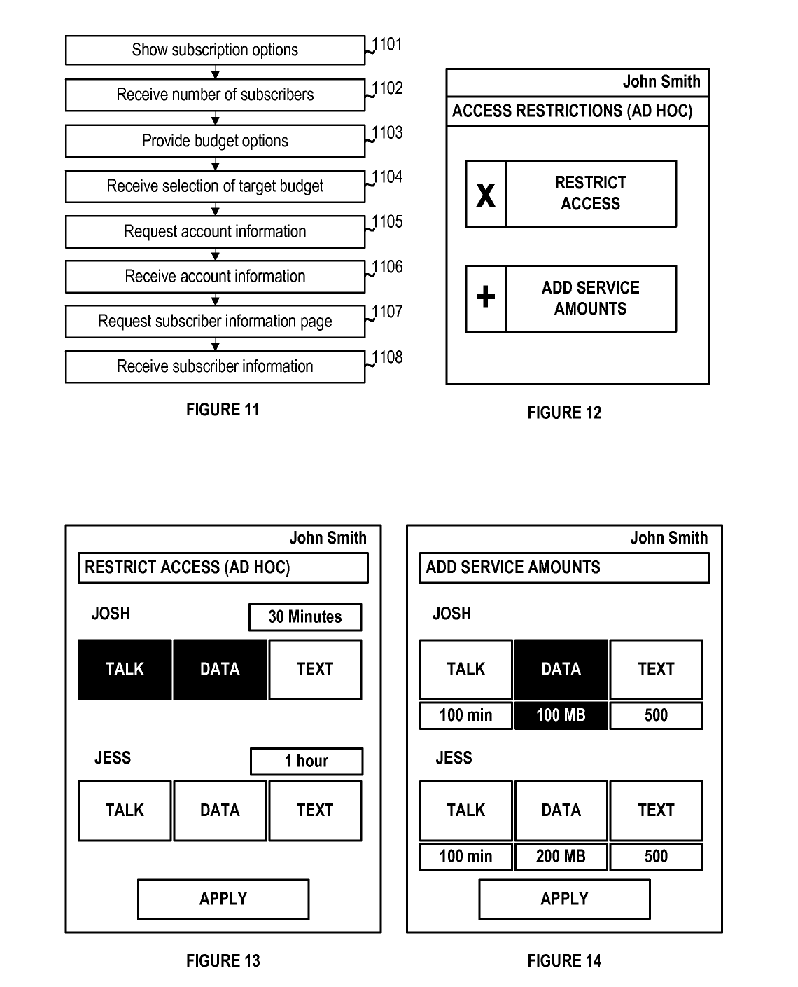

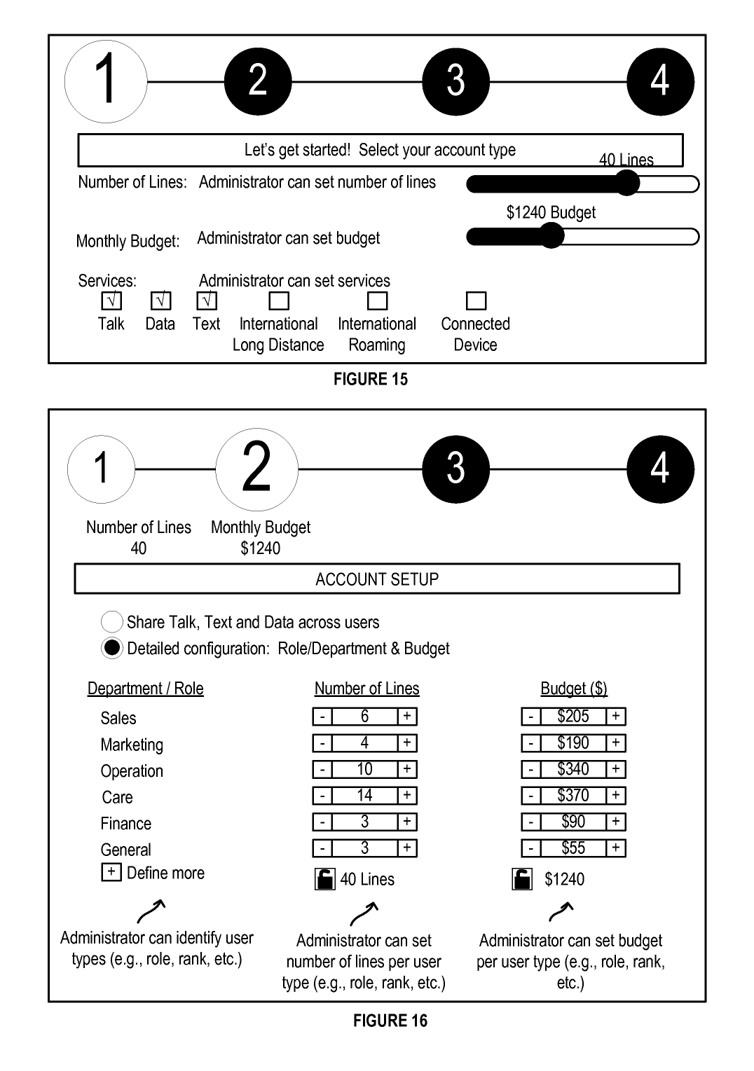

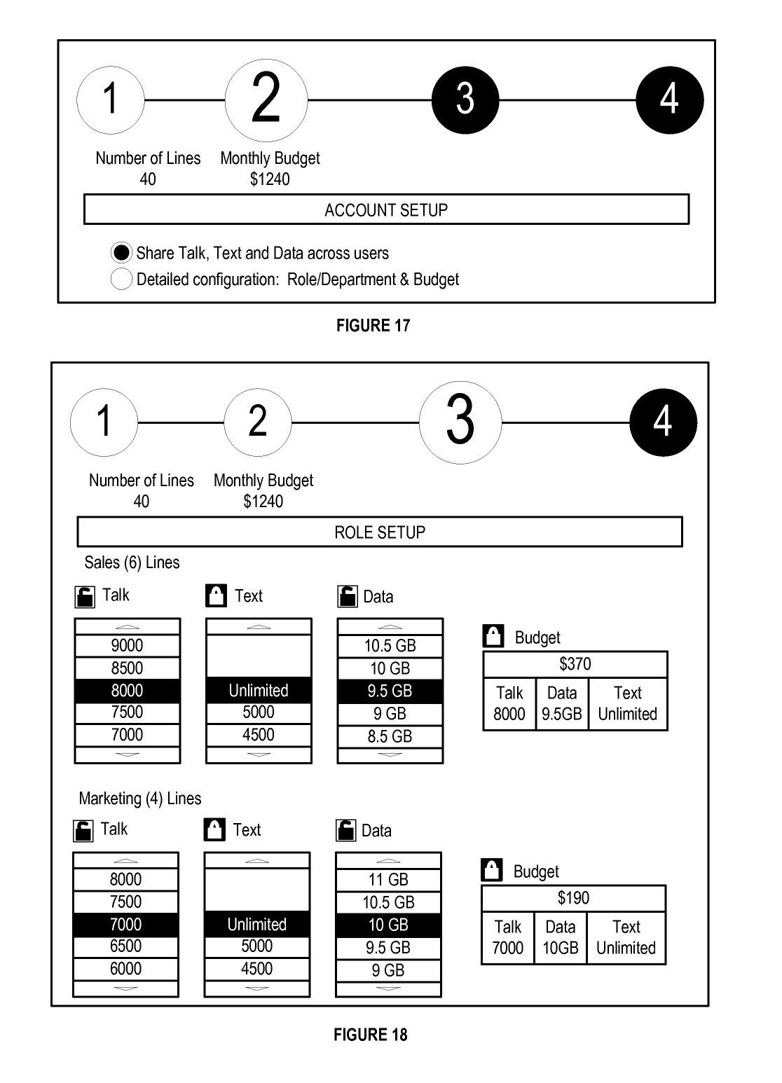

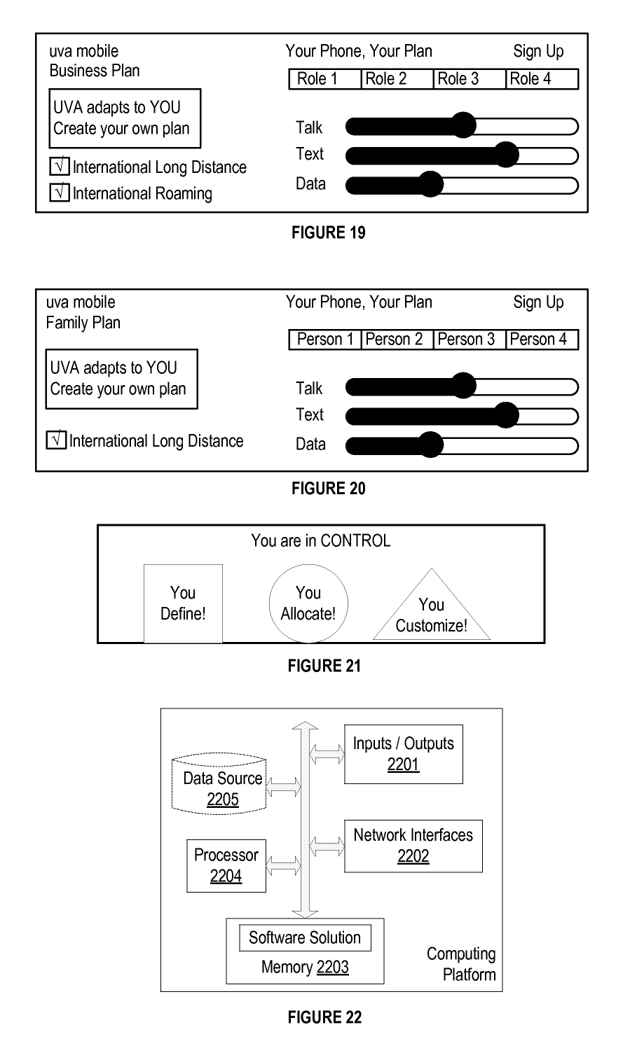

By way of example, FIG. 11 illustrates a process flow relating to establishing a service plan for multiple subscribers using the user interface of FIG. 3. As shown, subscription options are provided (1101), a number of subscribers is received (1102), budget options are provided (1103), a selection of a target budget is received (1104), a request for account information is provided (1105), account information is received (1106), a request for subscriber information is provided (1107), and subscriber information is provided (11080. Modification of Service Amounts

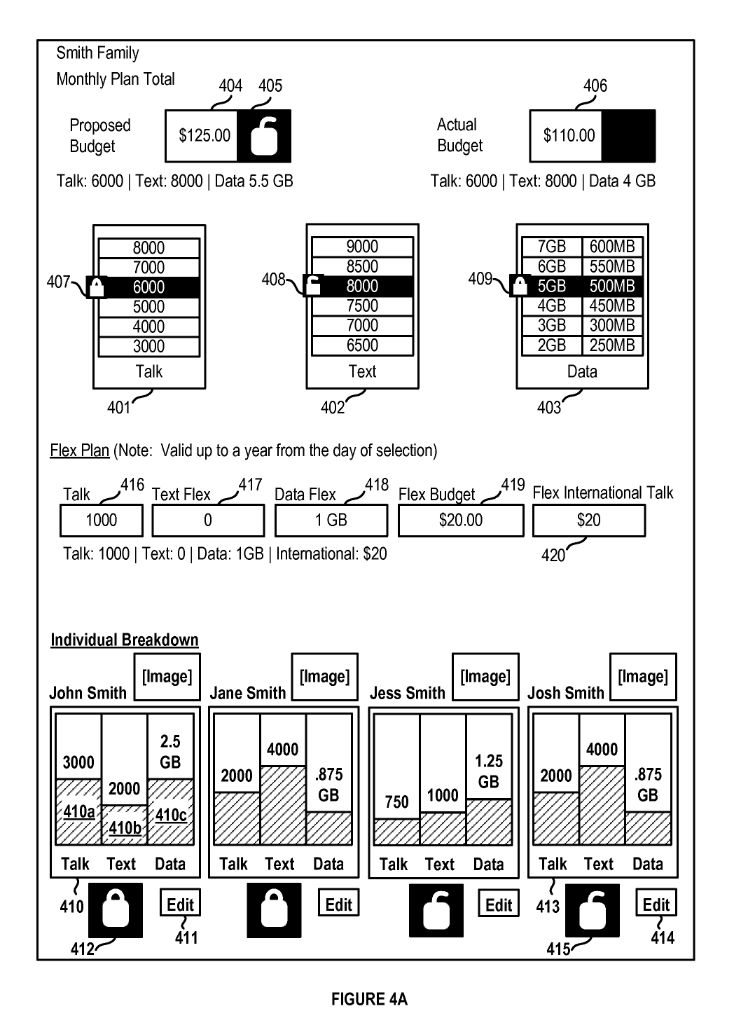

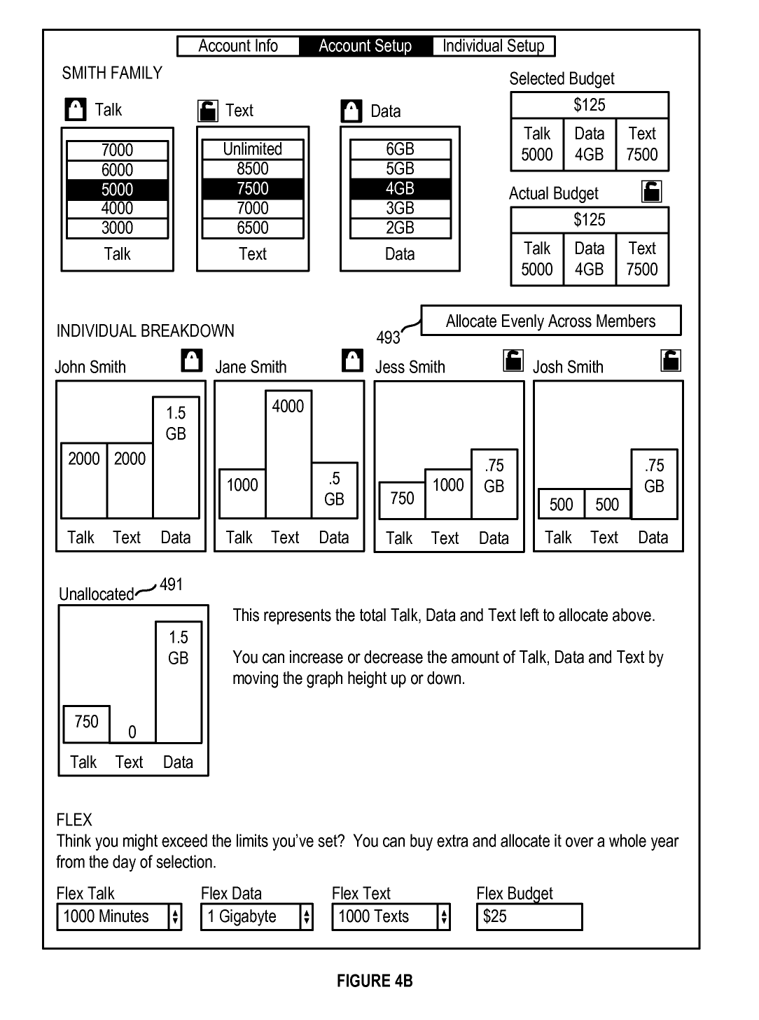

As shown in FIG. 4A, a user interface provides plan information to an administrator, and receives input from the administrator. As indicated above, subscriber information may be used to set default talk (401), text (402) and data (403) service amounts for a group's plan that fits a proposed budget (404) set by the administrator. Service amounts for each subscriber may also be set to default values.

An administrator may adjust any of the default talk (401), text (402) and data (403) service amounts. The administrator may also adjust service amounts (410 for John Smith, 413 for Josh Smith) for talk, text and data by selecting an edit option (411 for John Smith, 414 for Josh Smith), and then modify the amounts corresponding to an individual service for a subscriber. Modification may be carried out via different means. In FIG. 4A, vertical sliders (410a, 410b, 410c) may be adjusted by an administrator. By comparison, a horizontal slider is shown in FIG. 7. Sliders of other orientations are contemplated. Other means for representing an amount of a service (e.g., individually or by comparison to other amounts), and for allowing an administrator to modify the amount are contemplated. For example, a display and input of a number may be used, geometric shapes that grow or reduce in size based on the amount may be used, and colors may be used, among other possibilities.

A user interface that is similar to that of FIG. 4A may be used to reallocate service amounts from one subscriber to another subscriber of the same plan during a use period (e.g., during a month) as needed. For example, amounts initially allocated to one subscriber that is on pace to use less than those initially allocated amounts may be reallocated to another subscriber who is on pace to use more than amounts that were initially allocated to that other subscriber. Allocation may be automatically determined or determined based on inputs from the administrator via the user interface. Opportunities to reallocate service amounts for a particular user, or among two or more users, may be limited each use period by a number of times, by desired volumes of re-allocation, or other parameters.

FIG. 4B depicts another user interface for creating, viewing and modifying a service plan for multiple subscribers in accordance with one or more embodiments. As shown, an unallocated portion 491 of the user interface displays remaining service amounts that can be distributed to one or more of the individuals (e.g., John, Jane, Jess, Josh). The separate amounts of unallocated talk, data and text may increase or decrease as the administrator decreases or increases amounts of talk, data and text allocated for one or more individuals. Showing unallocated amounts using the unallocated portion (491) of the user interface may be used instead of, or in addition to, automatic reallocation of service amounts upon an administrator's modification to a particular service amount for a particular service as described elsewhere herein.

Automatic adjustments and determinations are adjustments and determinations made by a computing platform or processor of that computing platform based on programmed instructions that, when executed, cause the computing platform or processor to generate the adjustments or determinations instead of receiving input from a user that specifies manual adjustments or determinations.

Although not shown, the user interface may suggest which service amount(s) for particular individual(s) should be adjusted by some or all of the unallocated amounts of the services. For example, in some embodiments, the user interface displays an indication that one user (e.g., Josh) should receive a portion of the 750 unallocated talk minutes. This suggestion may be based on demographic data or historical use data relating to Josh or other users

The user interface of FIG. 4B also permits the administrator to select an “Allocate Evenly Across Members” option (493) that operates to assign unallocated amounts of selected service to all users or selected users. The amounts assigned to each user may be equal or based on predefined percentages (e.g., John receives 33%, Jane receives 33%, Jess receives 20%, and Josh receives the remaining amount).

### Locking Service Amount(s)

When the proposed budget (404) is locked (405), a reduction or increase to one of the service amounts (401, 402, 403) may result in an automatic increase or reduction of another one of the service amounts (401, 402, 403) based on per unit costs of each service (e.g., adding a text costs $1, resulting in 10 minutes valued at $1 being subtracted). Adjustments to one type of service may automatically adjust another type of service. Adjustments to total service amounts may adjust individual service amounts, and adjustments to an amount of a first service allocated to a subscriber may automatically adjust a total amount of that first service for the group, a total amount of another service for the group, an amount of another service allocated to that subscriber, an amount of the first service allocated to another subscriber, or an amount of another service allocated to the other subscriber depending on which amounts are locked. The automatic adjustments may be made to unlocked service amounts, and may be made based on subscriber information (e.g., type of user, where amounts associated with particular types of users are adjusted before amounts associated with other types of users).

By contrast, a reduction or increase to one of the service amounts (401, 402, and 403) may result in an automatic increase or reduction of the actual budget (406) when the proposed budget (404) is unlocked. By way of example, FIG. 4A illustrates an unlocked, proposed budget of $125.00 and an actual budget of $110.00, which results when the administrator adjusts an initial amount of a talk service to 6,000 minutes, an initial amount of a text service to 8,000 messages, and/or an initial amount of a data service to 5.5 GB of data.

An administrator may lock the budget (405), the total talk service amount (407), the total text service amount (408), and/or the total data amount (409). The administrator may also lock an individual subscriber's breakdown of services—e.g., service amounts for John Smith are locked (412) while service amounts for Josh Smith are not locked (415). Although not shown, different combinations of a subscriber's individual service amounts can be locked and unlocked (e.g., talk is locked, while text and data are unlocked for one of the subscribers). Locking a service amount enables an administrator to fix certain service amounts for certain subscribers—e.g., a subscriber that historically uses or needs 3,000 minutes of a talk service.

Any means for depicting that an amount is locked or unlocked are is contemplated. FIG. 4A illustrates a closed lock (412) for amounts that are locked, and further illustrates an opened lock (415) for amounts that are unlocked. Different colors may also be used.

### Generating Default Service Amounts

Amounts of a service may be determined based on demographic data, historical use data, personal information, and other data collected and stored by the provider platform 110.

In one implementation, demographic information about a subscriber, historical usage patterns related to that subscriber, and/or other information may be used to determine default values for that subscriber. This process may be repeated for each subscriber. Finally, a total value for each service may be determined by summing the individual subscriber values for those services.

Certain service amounts may automatically be locked. For example, if historical use data indicates that a particular subscriber consumes 50 texts each month on average, consumes 100 text messages during the school year, or has started consuming 70 messages since that subscriber's social status changed (e.g., a social network status changed to ‘In a Relationship’ or ‘Single’ or ‘New mom’), that subscriber's text service amount may be set and locked at that number of texts until circumstances change (e.g., the average use changes, the school year ends, or the social status changes).

By way of another example, if a subscriber's calendar describes business or personal events, default service amounts may be generated and locked based on information associated with those events. For instance, such events may be a sales call, a deal, family travel overlapping with a deadline, a social event that requires coordination using the service, or some other event that may impact a subscriber's use of the service amounts. An event that indicates foreign travel may be detected and used to suggest foreign service amounts for during the usage period(s) that overlap that detected foreign travel.

As indicated above, default allocation of service amounts can be carried out using different approaches. One approach is illustrated below, where the default allocation is based on demographics. Table 1 (below) indicates percent changes to initial allocations of service amounts. The initial allocations may, for example, be an even split of total service amounts based on the number of users (e.g., 5 users and 500 text messages initially allocated as 100 text messages per user). Alternatively, the initial allocations may be based on other predefined allocations.

TABLE 1
Percent modifications to initial distribution
of service amounts per user type

| Demographics | | | |
|---|---|---|---|
| classification | Talk | Text | Data |
| Kid | −25% | −5% | −15% |
| Teen | +25% | 0 | 0 |
| Young Adult | 0% | +5% | 0 |
| Adult | 0% | −15% | −15% |
| Seniors | −30% | −80% | −40% |

As illustrated by Table 1, demographic information may indicate that kids use 25% less talk minutes than young adults, or may use 25% less talk minutes than an average user. Teens, on the other hand, may use 25% more talk minutes than the average users or a young adult. Of course, percentages may be assigned to different classes of users based on alternative considerations other than average users or other classes of users. The percentage allocation may be driven by values defined by historical data across a set of users. Additionally, the percentages may be modified as historical data changes.

For some embodiments, percentage reductions may not be used. Instead, where historical data indicates that a certain amount of a service is used on average by a class of user, the default amount for a user of that class may be set at the average service amount.

For some embodiments, no reductions are made that would result in a default service amount falling below a minimum amount of that service.

Table 2 (below) illustrates how percentages may be used to determine default service amounts for a group of five members corresponding to 2,000 total talk minutes.

TABLE 2
Determination of default Talk service
amounts for group of five users

| | | | | | Unallo- | |
|---|---|---|---|---|---|---|
| | | | Amount | | cated | |
| Demographic | Initial | % | of | New | Distri- | Final |
| Classification | Distrib. | Change | Change | Distrib. | bution | Distrib. |
| Kid | 400 | −5% | −20 | 380 | | 380 |
| Teen | 400 | 0% | 0 | 400 | 200 | 600 |
| Young Adult | 400 | +10% | 40 | 440 | 200 | 640 |
| Adult | 400 | −15% | −60 | 340 | | 340 |
| Seniors | 400 | −90% | −360 | 40 | | 40 |
| | | | −400 | | | 2000 |

As shown by Table 2, an initial distribution of 400 minutes per user is determined (i.e., 2,000 minutes divided by 5 users equals 400 minutes per user). The initial amounts are then modified by predefined percentages to obtain a new distribution. After the new distribution, the unallocated amounts are then distributed to some or all of the users. Table 2 illustrates even distribution to two users. However, uneven distribution is possible, as is distribution to any sub group of users from the group of users.

### Selection of Extra Service Amounts

FIG. 4A also depicts a “Flex Plan” option that sets aside extra amounts of services for later use over the course of several use periods (e.g., a year during which 12 monthly service periods occur). The amounts may be allocated automatically or by the administrator to different subscribers as needed. For example, if one subscriber is on pace to exceed an amount of a service allocated for that subscriber during a particular use period, then a portion of the “flex plan” amount for that service may be allocated to that subscriber for use during that use period. The administrator may be alerted by a subscriber or the provider platform 110 when a service amount may be exceeded, or is exceeded, so that the administrator may allocate the extra service amounts as needed.

As shown in FIG. 4A, an administrator may select amounts for talk (416), text (417), or data (418), which may populate a budget amount (419) that may be adjusted by the administrator. Alternatively, the administrator may select a budget (419), which may result in the generation of default amounts of talk (416), text (417), and data (418) that may be adjusted by the administrator. The generated amounts of default talk, text and data services may be based on a different cost scale than the generated amounts of talk, text and data services based on the proposed budget (404) so as to encourage an administrator to purchase those service amounts. An administrator may also purchase an amount of an international talk service (420) for later use.

### Allocation of Extra Service Amounts

FIG. 12 depicts a user interface associated with a computer application for selecting a first option that restricts access to one or more services or a second option that increases amounts of one or more services in accordance with one or more embodiments. FIG. 14 depicts a user interface relating to the second option of FIG. 12 in accordance with one or more embodiments. As illustrated by FIG. 14, amounts of talk, data, and text may be added to service amounts corresponding to different users. For example, 100 minutes of a talk service may be added to Josh and Jess, 200 MB of a data service may be added to Jess (while no MB of the data service are added to Josh), and 500 messages of a text service are added to Josh and Jess. Although not shown, the user interface of FIG. 14 could be used to reduce service amounts. When services amounts to add are selected, the administrator may select ‘Apply’ to add the designated amounts.

### Modification of Service Amounts for Subscriber

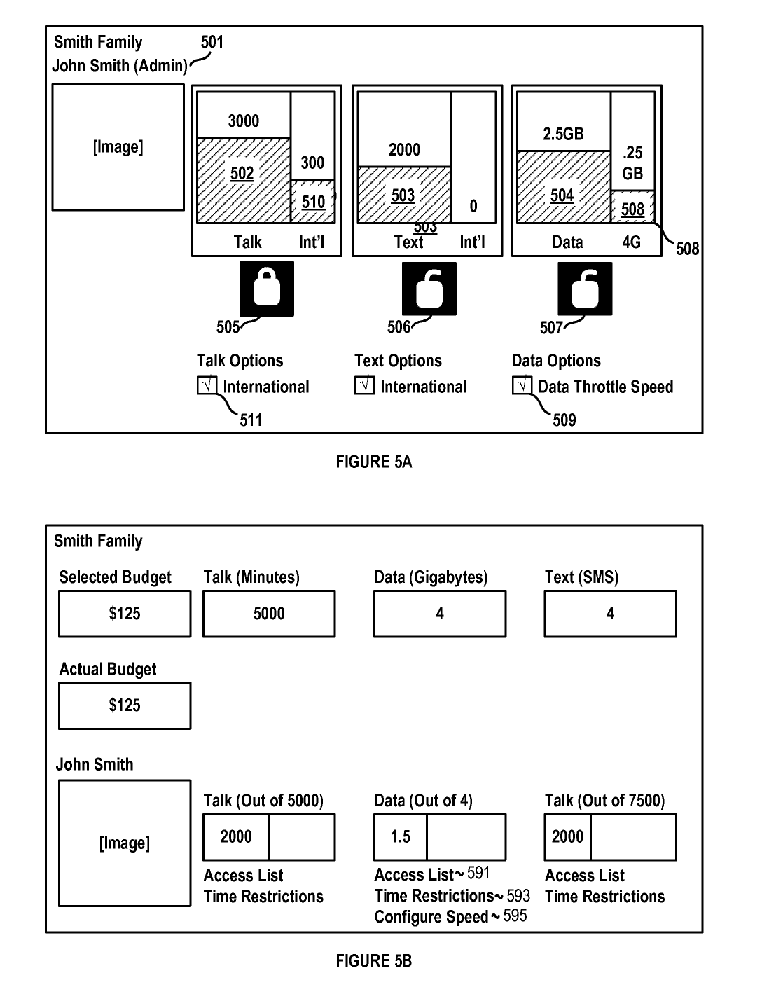

FIG. 5A depicts a user interface that provides information to an administrator relating to the allocated services amounts for an individual subscriber (501), and receives input from the administrator. As indicated above, that stored data may be used to set default talk (502), text (503) and data (504) service amounts for the subscriber (501). Particular service amounts may be locked (505 for talk) or unlocked (506 for text, 507 for data).

As shown in FIG. 5A, an administrator may partition amounts of services to different categories. For example, a portion of data allocated to the subscriber may be designated for 4G (508) and slower speeds (504). Such allocation may be enabled by selecting the ‘Throttle Data Speed’ option (509). Although not shown, the administrator may designate use periods during which particular data speeds are available (e.g., towards the end of the month, during particular times of the day, on weekends, during travel, etc.). Alternatively, use of certain speeds may be restricted to particular types of content (e.g., video content, but not textual content), or based on a detected location of a user (e.g., when the user is at school, in a business meeting, or during a subscriber's commute). Use of certain speeds may also be controlled by the remaining balance of the data service for a user period.

FIG. 5A also depicts international talk minutes (510) that are available when the administrator selects the international talk option (511).

Attention is now turned to FIG. 5B, which illustrates another user interface. As shown, the user interface of FIG. 5B provides three options: an access list option (591); a time restrictions option (593); and a configure speed option (595). The access list option 591 permits the administrator to edit authorized and unauthorized lists of web content, people and other sources tied to use of services by individual users. The time restrictions option 593 permits the administrator to edit service use restrictions for individual users. The configuration speed option 595 permits the administrator to edit data throttling configurations for individual users.

### Data Throttling

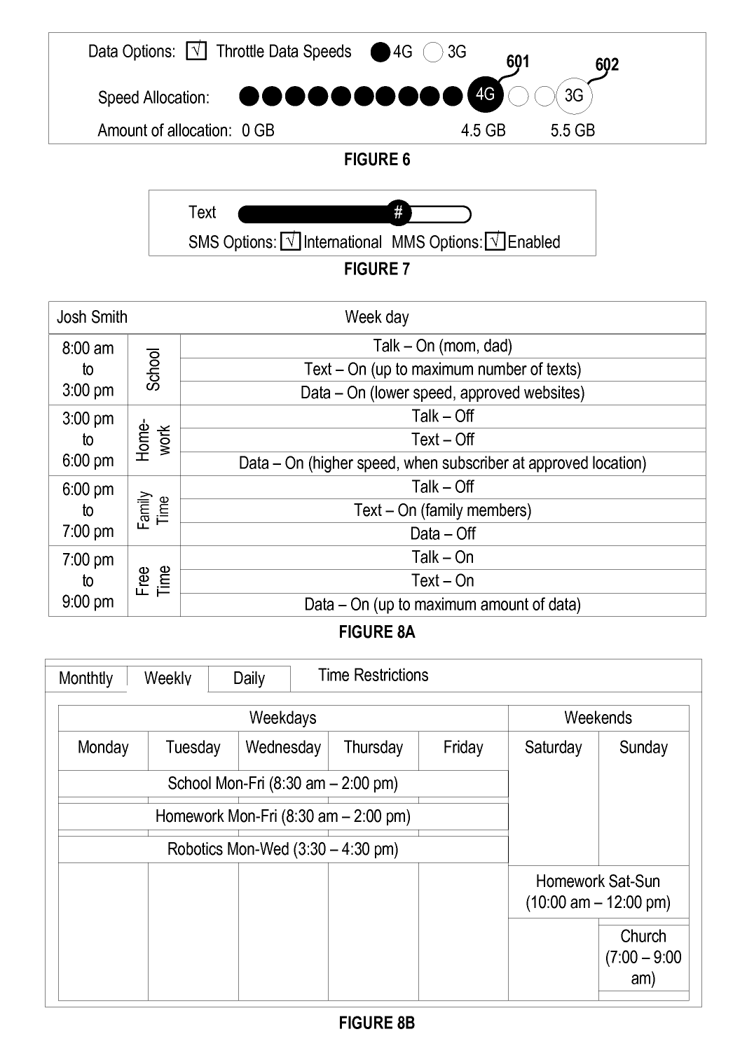

FIG. 6 illustrates additional details related to one implementation of data throttling (among many implementations). As shown, an amount of the data may be allocated to 4G/higher speeds (601), and a remaining amount may be allocated to 3G/slower speeds (602). The amounts may be a percentage of the total amount, or the exact amount (as shown in FIG. 6). The throttling may designate that higher speeds are used up until the fixed amount of data for the higher speeds is reached, and then slower speeds are used.

### Adjustment of Service Amount Based on Modification

An administrator may input modifications to service amounts. When the budget is unlocked, such modifications may results in increasing or decreasing the budget. However, when the budget is locked, additional processing may be necessary to adjust another service amount based on the modification so the budget unchanged.

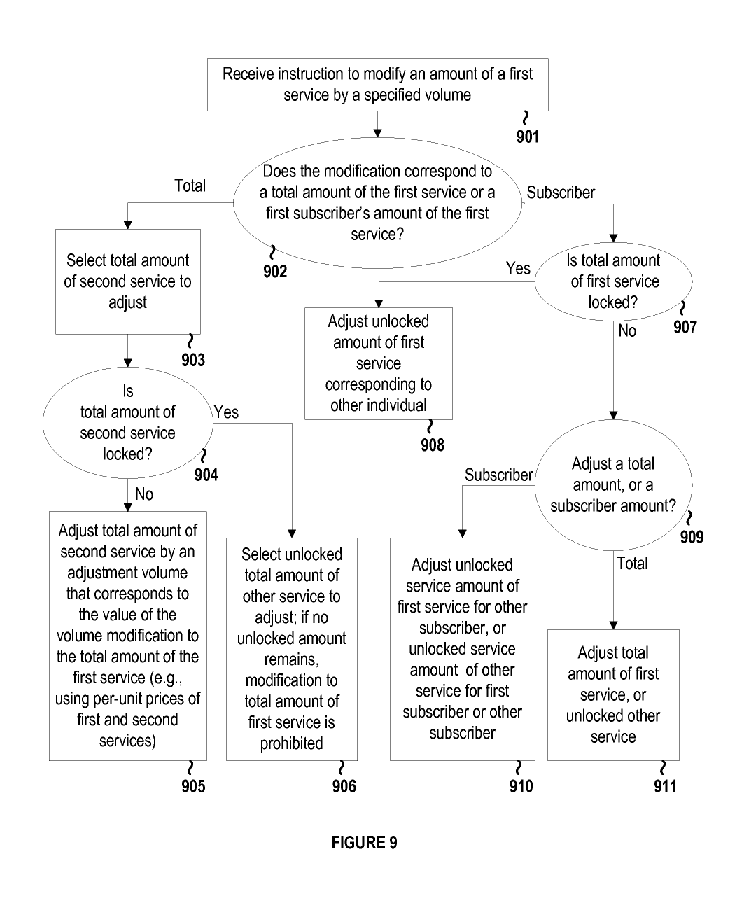

FIG. 9 depicts a process for determining which service amount(s) are adjusted when another service amount is modified.

As shown, an administrator may request a modification to an amount of a service by a specified volume of change (901). The provider platform 110 determines if the requested modification corresponds to a total amount of the service, or an individual subscriber amount of the service (902).

When the amount of the service is a total amount of the service, a total amount of a second service is selected to be adjusted (903). The provider platform 110 determines whether the total amount of the second service is locked (904). If it is unlocked, the total amount of the second service is adjusted by an adjustment value corresponding to the value of the modification volume (905). Otherwise, an unlocked total amount corresponding to another service is selected for adjustment (906). If there is no unlocked total amount, then the request to modify the total amount of the first service is denied.

The value of the adjustment amount may be equal to the value of the modification amount as determined using a per-unit-of-service cost value. For example, if a minute costs $0.01, and a text costs $0.10, an increase of 100 minutes ($1) would result in a decrease of 10 texts ($1). Of course, modification of one service amount (e.g., talk) may result in adjustment to two or more other service amounts (e.g., text and data).

When the amount of the service is a subscriber amount of the service, a determination is made as to whether the total amount of the service is locked (907). If it is locked, the total amount of the service cannot change, and thus another subscriber's amount of the service must be adjusted (908). If the total amount of the service is unlocked, the provider platform 110 determines if an adjustment will be made to an unlocked total amount of any service, or an unlocked subscriber amount of any service (909). A subscriber amount is adjusted (910)—e.g., another subscriber's amount of the service or a different service, or the same subscriber's amount to a different service. An unlocked total amount of the service or another service is adjusted (911).

### Identifying Different Types of Users, and Setting Service Amounts for Different Types

FIG. 16 depicts a user interface for identifying different types of users (e.g., sales, marketing, operation, care, finance, general), setting a number of users per type of user (e.g., a number of lines), and setting a budget per user type, group of users or users. FIG. 18 depicts a user interface for setting particular amounts of services to particular types of users. Of course, the amounts of services for a particular type of user can be further separated to each user.

### Controlling a Subscriber's Use of Services

In general, an administrator may configure use parameters that limit or enable a subscriber's use of a service. The provider platform 110 or that subscriber's platform 130 may consult those use parameters to determine what services to provide the subscriber under different circumstances (e.g., time of day, location of subscriber, remaining balance of subscriber's amount of a service, or other detectable conditions).

In one implementation, the provider platform 110 may access the use parameters to control which services are provided to a subscriber, and how they can be used by that subscriber. By way of example, the use parameters may be correlated to an identifier received from the subscriber platform 130 (e.g., a mobile phone identifier, a subscriber identifier, or other identifier), a processor at the provider platform 110 may recognize the identifier and may then limit the services provided to the subscribe platform 130.

In another implementation, the subscriber platform 130 may block or enable certain uses of services using software or firmware that executes on the subscriber platform 130. The software may be downloaded to the phone via a data connection or through other means (e.g., SIM card, firmware at the time of manufacture).

### Configuration of Use Parameters

Attention is now drawn to FIG. 8A, which depicts a user interface through which an administrator controls when an individual subscriber (e.g., Josh Smith) can use particular services (e.g., talk, text, and data). Attention is also drawn to FIG. 8B, which depicts another user interface through which an administrator controls when use restriction periods are scheduled. Although not shown in FIG. 8B, such use periods relate to use of particular services like talk, text, and data by one or more individual subscribers. Various options for designating months, days or hours/minutes are contemplated, including sliders and selection of boxes next to particular months, days, or hours/minutes.

As shown in FIG. 8A, an administrator may select a service, and then designate use parameters for that service. The administrator may also select a time during which the use parameters apply to the service (e.g., during a present or future time period). Such use parameters may include: on/off; maximum amount of use (e.g., maximum number of texts or amount of data); on, but with limitations (e.g., websites or applications the subscriber can use, authorized or unauthorized people for incoming and outgoing calls or texts, data speeds, location of subscriber); and other parameters.

Use parameters may alternatively go into effect based on a detected location of a subscriber platform 130. There are various means that can detect location, including satellite and terrestrial beacon networks (e.g., GPS, A-GPS, other positioning systems), local network detection (e.g., Wi-Fi), and other techniques to detect whether a subscriber is within a geographic area (e.g., NFC, RFID, others).

The administrator may set up categories (e.g., school, homework, family time, free time, other) that correspond to different use parameters of services for a subscriber. Historical use of services can be surveyed and associated with locations of that use, and this surveyed information can be used to designate use parameters associated with a surveyed location. Once set up, the administrator may select a time period and category (as compared to having to select particular use parameters for different services each time the administrator selects a time period).

Use parameters may be modified automatically or by an administrator as circumstances change. For example, if the subscriber is using too much of one service, a maximum limit on use for that service may be triggered, or the service may be turned off. Similarly, a need to conserve amounts of a service may be detected (e.g., an event/activity scheduled in a subscriber's calendar), which may trigger the system to turn off, throttle or otherwise limit that service until it is needed.

Alternative user interfaces are contemplated, including user interfaces that allow an administrator to designate use parameters on a weekly and monthly scale, and that allow an administrator to cause use parameters to take immediate effect—e.g., where the administrator either later removes the use parameters or the use parameters are removed automatically (e.g., after a time set by the administrator expires). Such user interfaces may allow an administrator to turn off or turn on a service on-demand (e.g., to punish/reward a child).

FIG. 12 depicts a user interface associated with a computer application for selecting a first option that applies use restrictions for one or more services by particular users, or a second option that increases amounts of one or more services in accordance with one or more embodiments. FIG. 13 depicts a user interface relating to the first option of FIG. 12 in accordance with one or more embodiments. The user interface in FIG. 13 permits an administrator to select types of services for individual users. As shown, a text service for Josh, and talk, data and text services for Jess are selected. Also, the administrator may select the duration of time during which those selected services will be deactivated or activated for each user. Alternatively, no time limit may be set, which would require the administrator to deactivate or activate the use restrictions. In some embodiments, such deactivation or activation could occur after the administrator receives a request from the restricted user. Once satisfied with the designated services, the administrator may apply the use restrictions, which then take immediate effect.

“Include” and “exclude” lists (or, white and black lists) are contemplated where an administrator may authorize or block incoming or outgoing phone numbers (for talk and text), URLS (for data), types of data requested for download, and other external identifiers.

Usage during peak hours may also be slowed or turned off to avoid usage penalties during peak hours, or to take advantage of benefits during non-peak hours.

### Granting or Restricting Access Based on Use Parameters

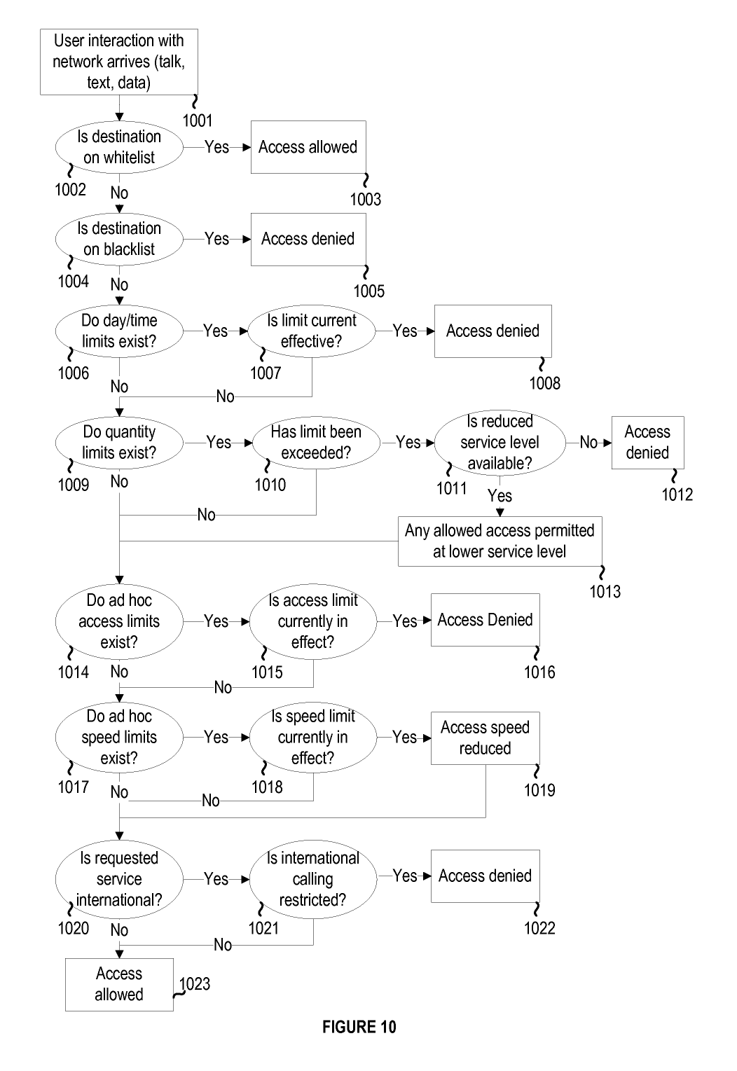

FIG. 10 depicts a process flow for determining whether any use parameters exist for a particular service that is requested by a subscriber/user under certain circumstances. As shown, a subscriber interaction is detected (1001). The interaction may be a request to access talk or text services by transmitting a phone call or a text message between the user and another user. Such a request may originate from either user. Alternatively, the interaction may be a request to transmit information between the user and a website or a remote computer application. Such a request may originate from the user or the website/remote application.

Upon detection of an interaction relating to a phone call or a text message, the other user's identifier (e.g., phone number or other identifier) may be compared to a “whitelist” of authorized identifiers and/or a “blacklist” of unauthorized identifiers (1002, 1004). For interactions relating to data service requests (e.g., requesting/transmitting information from/to a website or remote computer application), an identifier of the website or application (e.g., web address) may be compared to one or more lists of authorized and unauthorized identifiers. If the identifier is listed as an authorized identifier, then the phone call, text message or data may be transmitted or received (1003). By contrast, if the identifier is listed as an unauthorized identifier, then the talk call, text message or data may be blocked (1005).

Use parameters may also be consulted to determine whether the phone call, text message, or data may be transmitted or received by the user. As shown, access to a service may be granted or denied based on use parameters that specify limits on use of a service based on various conditions, including: preset limits on a day and/or time period (1006, 1007, 1008); limits based on a maximum amount of use (1009, 1010, 1011, 1012, 1013); dynamically allocated ad hoc limits presently set (1014, 1015, 1016); limits based on a speed at which data is transmitted (1017, 1018, 1019); limits on a destination of a phone call (e.g., international) (1020, 1021, 1022); and other limits relating to whether a subscriber/user may access a service (e.g., the subscriber's location).

### Tracking a Subscriber's Use of Services

Usage patterns may be determined based on collected use data. Such patterns may identify particular services, time periods of use, volume of use, location of use, correlation of use to personal information (e.g., calendared events/activities), correlation of data use to website or computer application, correlation of phone call/text message to recipient/sender, and other data. Usage patterns may be used to determine default amounts of services, or to suggest modifications to current amounts of services.

A subscriber's location may also be tracked and used to allow or restrict use of a service. The location may alternatively be used to reward a subscriber for certain behavior (e.g., use of carpooling as detected by co-location with another user), attending an event, making a purchased at a store (e.g., as detected by location and possibly a tracked credit card transaction). The reward may provide the subscriber with additional amounts of a service (e.g., an amount of minutes, texts and/or data) that can be used during the current use period, applied to later use periods, or given to other subscribers.

### Discounted Mobile Line Plans

Certain aspects of this disclosure relate to discounted mobile line plans that designate one or more discounted lines to subscribers within certain group accounts (e.g., family accounts) based on overall account budget and/or total number of lines. These plans are designed to meet market needs in relation to lower-feature sets for certain classes of subscribers (e.g., children, young adults, seniors, visitors, one-time users, short-term user, or infrequent users). These plans advantageously increase customer loyalty, and widen subscriber base by offering additional low-usage or restricted-feature lines, which reduces loss of customers to competitors offering fixed lower-per-line prices.

### M+N Plans

M+N plans include discounted mobile line plans where M stands for number of subscribers in a qualifying family account, and N represents the number of eligible discounted lines. These M+N plans advantageously appeal to users who need limited feature lines, can tolerate limited feature lines due to restricted budgets, and need “stand-by” phones for occasional use. For instance, parents may want children and young adults to use phones for emergency purposes and not take time away from studies. Senior citizens typically may also have lower usage profiles and may not even need certain services like a data service. Access to services may be desired by guests staying over for a few days or to keep a second emergency phone. Availability and access to the additional lines are dependent on total budget (e.g., availability is provided when a total budget exceeds a threshold amount, and access may be restricted to certain time periods). Under a 2+1 plan, for example, an extra line may be available to a family that uses two lines and pays a certain budget (e.g., >$100.00) per month.

### Implementation of M+N Plans

M+N plans may include a combination of full-price lines (M) and discounted lines (N), where the number of discounted lines N depends on a total budget B. The discounted lines can also be classified into different categories (e.g., basic/default line and X line, with the X lines having more options available like more times or locations when accessible, more services and/or higher quantities of services compared to the basic/default line. The number and values of options may be dependent on the budget. For example, a minimum budget B (e.g., $50/month) may permit the basic line with some baseline feature set (e.g., 250 minutes of a talk service, 250 MB of a data service, and 250 messages of a text service). A budget of twice B may permit a single line with twice the feature set of the basic line, or may permit two basic lines. One implementation for determining available features is illustrated below in Table 3.

TABLE 3
Example embodiment for determining feature sets

| | Possible Basic | Possible X | |
|---|---|---|---|
| | Lines (e.g., | Lines (e.g., | Possible |
| | basic features: | twice the | Allocation |
| Total | # Min, # Data, | basic | (Basic line) + |
| Budget | # Texts) | features) | (X line) |
| <$50 | n/a | n/a | n/a |
| $50 | 1 | n/a | 1 + n/a |
| $100 | 2 | 1 | 2 + 0; or 0 + 1 |
| $150 | 3 | 1 | 3 + 0; or 1 + 1 |
| $200 | 4 | 2 | 4 + 0; 2 + 1; or 0 + 2 |

### Use Cases

Many examples herein have been provided in relation to a family of subscribers. Other groups of subscribers are contemplated, including organizations (e.g., private, public and other entities). For instance, a business may allocate and control access to service amounts for different types of employees.

Many examples have been provided from a view point of an administrator that receives information and inputs selections into a user interface. One of ordinary skill in the art will understand that a provider platform 110 sends the information and receives the selections. The provider platform 110 further stores data corresponding to the information and the selections, and then uses that stored data to determine when to provide different subscribers access to services, or when to restrict access to the services by the different subscribers. The provider platform 110 may further collect and store information regarding the use of subscribers, and then use that usage information to carry out various functions (e.g., generation of default service amounts, determining pricing models for different types of groups). The provider platform 110 may also correlate usage information across subscribers of similar demographics (e.g., age, gender, location) to further refine its performance of the functions.

### Advantages of Methodologies

Practice of the methods disclosed herein offer many advantages over predecessor approaches, including: (a) providing enhanced computer operations that would otherwise be unavailable without practicing the methods disclosed herein; (b) allowing users to participate in activities that are otherwise unavailable to those users without practice of the methods disclosed herein; (c) creating new information and using that new information to enhance computer operations, including display of never-seen-before data via a graphical user interface based on analysis of the new information; (d) giving certain users more-favorable options compared to options that were previously available; and/or (e) permitting two or more computing devices to interact with each other in various ways that are not possible without practicing the methods disclosed herein.

Various methods disclosed herein improve various technical fields (e.g., radio and other network communications) by offering the following solutions to problems encountered in those fields: offering variable levels of services to users at different times, days, weeks, and months; creating new sources of revenue for network operators; providing more service options that support and enhance budgeting activities of families and other groups of users; increasing administrative control of when, how and where different users can access services; adjusting an allocated service amount for a particular user based on a modification to another allocated service amount and further based on user input that prevents certain allocated service amounts from being modified or adjusted; generating information for use by network operators when investing in network resources; reducing time required to set service options for a group of users; and others.

Various methods disclosed herein use information in a new way that did not exist before this disclosure, including: using historical data to determine adjustments to future service allocations; displaying real-time, automatic adjustments to an allocation of a service based on a modification to another allocation of another service; displaying real-time, automatic adjustments to an allocated portion of a service for a user based on a modification to another allocated portion of that service for another user; receiving real-time or pre-set use parameters, and using those parameters to control operations of a computing device; and others.

Various aspects disclosed herein are non-conventional and not previously known to the telecommunications industry. For example, network operators can now benefit from increased user satisfaction by offering those users greater flexibility in allocating service amounts to different users of a group. Administrators can now lock allocations of a service amount for a user of a group, while modifying and adjusting remaining service amounts to fit a desired budget. Users are now able to visualize the effect a modification to an allocated service amount has on other allocated service amounts with greater efficiency and lower cost. Network operators can more-easily increase or decrease the cost of services to users based on current or projected use of network services and associated network components. The cost of a particular service can now be used to determine an automatic adjustment to an allocated service amount based on a user modification to another allocated service amount.

### Other Aspects

Use of the techniques described herein may be extended to a commodity associated with communication services (e.g., cellular services and the like), or other services. Other communication services include Wi-Fi, television channels, and other over-the-air or wired services.

Functionality and operation disclosed herein may be embodied as one or more methods implemented, in whole or in part, by machine(s)—e.g., processor(s), computers, or other suitable means known in the art—at one or more locations, which enhances the functionality of those machines, as well as computing devices that incorporate those machines. Non-transitory machine-readable media embodying program instructions adapted to be executed to implement the method(s) are also contemplated. Execution of the program instructions by one or more processors cause the processors to carry out the method(s).

It is noted that method steps described herein may be order independent, and can therefore be performed in an order different from that described. It is also noted that different method steps described herein can be combined to form any number of methods, as would be understood by one of skill in the art. It is further noted that any two or more steps described herein may be performed at the same time.

By way of example, not by way of limitation, method(s) and processor(s) or other means may: generate an allocation of services for a group of users (e.g., subscribers) that specifies an amount of time units for a phone call service, an amount of messages for a text messaging service, and an amount of data for a data service; generate a respective allocation of the services for each of the users that specifies portions of the amount of the time units, the amount of the messages, and the amount of the data; and receive data that specifies a modification to (1) the amount of time units, (2) the amount of messages, (3) the amount of data, or (4) a first portion of the amount of the time units, the amount of the messages, and the amount of the data allocated to a first user.

In accordance with some aspects, the method(s) and processor(s) or other means may further or alternatively: identify one or more locked statuses indicating whether one or more of the following can be adjusted: (1) a payment amount set by one of the users, (2) the amount of time units, (3) the amount of messages, (4) the amount of data, and (5) a second portion associated with another one of the services allocated to the first user or associated with one of the services allocated to a second user; and generate one or more adjustments to one or more of (1) the payment amount, (2) the amount of time units, (3) the amount of messages, (4) the amount of data, and (5) the second portion based on the modification and the one or more locked statuses.

In accordance with some aspects, the method(s) and processor(s) or other means may: identify one or more locked statuses indicating whether a third portion associated with one of the services allocated to the second user can be adjusted; and generate one or more adjustments to the third portion based on the modification and the one or more locked statuses.

In accordance with some aspects, the one or more locked statuses include a locked status indicating that the payment amount set by one of the users cannot be adjusted.

In accordance with some aspects, the modification is to a first one of (1) the amount of time units, (2) the amount of messages, and (3) the amount of data, and wherein the one or more adjustments include an adjustment to a second one of (1) the amount of time units, (2) the amount of messages, and (3) the amount of data.

In accordance with some aspects, the method(s) and processor(s) or other means may further or alternatively: determine whether a third one of (1) the amount of time units, (2) the amount of messages, and (3) the amount of data cannot be adjusted; and generate the adjustment to the second one of (1) the amount of time units, (2) the amount of messages, and (3) the amount of data upon determining that the third amount cannot be adjusted.

In accordance with some aspects, the modification is to the first portion, and wherein the one or more adjustments include an adjustment to the second portion.

In accordance with some aspects, the first portion and the second portion are allocated to a first user.

In accordance with some aspects, the modification is to the first portion that is allocated to a first user, wherein the one or more adjustments include an adjustment to the third portion that is allocated to a second user, and wherein the first portion and the third portion are both included in a first one of (1) the amount of time units, (2) the amount of messages, and (3) the amount of data.

In accordance with some aspects, the modification is to the first portion, and wherein the one or more adjustments include an adjustment to one of (1) the amount of time units, (2) the amount of messages, and (3) the amount of data.

In accordance with some aspects, the first portion is not included in the one of (1) the amount of time units, (2) the amount of messages, and (3) the amount of data.

In accordance with some aspects, the first portion is included in the one of (1) the amount of time units, (2) the amount of messages, and (3) the amount of data.

In accordance with some aspects, the modification is to one of (1) the amount of time units, (2) the amount of messages, and (3) the amount of data, and wherein the one or more adjustments include an adjustment to the second portion.

In accordance with some aspects, the second portion is included in the one of (1) the amount of time units, (2) the amount of messages, and (3) the amount of data.

In accordance with some aspects, the second portion is not included in the one of (1) the amount of time units, (2) the amount of messages, and (3) the amount of data.

In accordance with some aspects, the second portion and a third portion are included in a different one of (1) the amount of time units, (2) the amount of messages, and (3) the amount of data, and wherein the third portion is locked so that the third portion cannot be changed.

In accordance with some aspects, the one or more locked statuses include a locked status indicating that a first one of (1) the amount of time units, (2) the amount of messages, and (3) the amount of data cannot be adjusted.

In accordance with some aspects, the modification is to a second one of (1) the amount of time units, (2) the amount of messages, and (3) the amount of data, and wherein the one or more adjustments include an adjustment to a third one of (1) the amount of time units, (2) the amount of messages, and (3) the amount of data.

In accordance with some aspects, the modification is to the first portion, and wherein the one or more adjustments include an adjustment to the second portion.

In accordance with some aspects, the first portion and the second portion are allocated to a first user.

In accordance with some aspects, the first portion is allocated to a first user and the second portion is allocated to a second user, and wherein the first portion and the second portion are included in the first one of (1) the amount of time units, (2) the amount of messages, and (3) the amount of data.

In accordance with some aspects, the first portion is allocated to a first user and the second portion is allocated to a second user, and wherein the first portion and the second portion are included a second one of (1) the amount of time units, (2) the amount of messages, and (3) the amount of data that can be adjusted.

In accordance with some aspects, the modification is to the first portion, and wherein the one or more adjustments include an adjustment to a second one of (1) the amount of time units, (2) the amount of messages, and (3) the amount of data.

In accordance with some aspects, the first portion is not included in the second one of (1) the amount of time units, (2) the amount of messages, and (3) the amount of data.

In accordance with some aspects, the first portion is included in the second one of (1) the amount of time units, (2) the amount of messages, and (3) the amount of data.

In accordance with some aspects, the modification is to a second one of (1) the amount of time units, (2) the amount of messages, and (3) the amount of data, and wherein the one or more adjustments include an adjustment to the second portion.

In accordance with some aspects, the second portion is included in the second one of (1) the amount of time units, (2) the amount of messages, and (3) the amount of data.

In accordance with some aspects, the second portion is not included in the second one of (1) the amount of time units, (2) the amount of messages, and (3) the amount of data.

In accordance with some aspects, the second portion and a third portion are included in a third one of (1) the amount of time units, (2) the amount of messages, and (3) the amount of data, and wherein the third portion is locked so that the third portion cannot be changed.

In accordance with some aspects, the one or more locked statuses include a locked status indicating that the second portion cannot be adjusted.

In accordance with some aspects, the modification is to a first one of (1) the amount of time units, (2) the amount of messages, and (3) the amount of data, and wherein the one or more adjustments include an adjustment to a second one of (1) the amount of time units, (2) the amount of messages, and (3) the amount of data.

In accordance with some aspects, the modification is to the first portion, and wherein the one or more adjustments include an adjustment to the third portion.

In accordance with some aspects, the first portion and the third portion are allocated to a first user.

In accordance with some aspects, the first portion is allocated to a first user and the third portion is allocated to a second user, and wherein the first portion and the third portion are included in the first one of (1) the amount of time units, (2) the amount of messages, and (3) the amount of data.

In accordance with some aspects, the second portion and the third portion are allocated to a first user.

In accordance with some aspects, the second portion is allocated to a first user and the third portion is allocated to a second user, and wherein the second portion and the third portion are included in the first one of (1) the amount of time units, (2) the amount of messages, and (3) the amount of data.

In accordance with some aspects, the modification is to the first portion, and wherein the one or more adjustments include an adjustment to a first one of (1) the amount of time units, (2) the amount of messages, and (3) the amount of data.

In accordance with some aspects, the first portion is not included in the first one of (1) the amount of time units, (2) the amount of messages, and (3) the amount of data.

In accordance with some aspects, the second portion is not included in the first one of (1) the amount of time units, (2) the amount of messages, and (3) the amount of data.

In accordance with some aspects, the first portion is included in the first one of (1) the amount of time units, (2) the amount of messages, and (3) the amount of data.

In accordance with some aspects, the second portion is included in the first one of (1) the amount of time units, (2) the amount of messages, and (3) the amount of data.

In accordance with some aspects, the second portion is not included in the first one of (1) the amount of time units, (2) the amount of messages, and (3) the amount of data.

In accordance with some aspects, the second portion is included in the first one of (1) the amount of time units, (2) the amount of messages, and (3) the amount of data.

In accordance with some aspects, the modification is to a first one of (1) the amount of time units, (2) the amount of messages, and (3) the amount of data, and wherein the one or more adjustments include an adjustment to the third portion.

In accordance with some aspects, the third portion is included in the first one of (1) the amount of time units, (2) the amount of messages, and (3) the amount of data.

In accordance with some aspects, the second portion is included in the first one of (1) the amount of time units, (2) the amount of messages, and (3) the amount of data.

In accordance with some aspects, the third portion is not included in the first one of (1) the amount of time units, (2) the amount of messages, and (3) the amount of data.

In accordance with some aspects, the second portion and a third portion are included in a second one of (1) the amount of time units, (2) the amount of messages, and (3) the amount of data.

In accordance with some aspects, the second portion is included in the second one of (1) the amount of time units, (2) the amount of messages, and (3) the amount of data.

In accordance with some aspects, the method(s) and processor(s) or other means may further or alternatively: identify data that specifies one or more use parameters for the first user; and prevent the first user from accessing one of the services based on the one or more use parameters.

In accordance with some aspects, the use parameters specify that a first user cannot use one of (1) the phone call service, (2) the text messaging service, and (3) the data service during a first time period on a particular day, or at a first location.

In accordance with some aspects, the use parameters specify that a first user cannot use one of (1) the phone call service, (2) the text messaging service, and (3) the data service based on a role of that user within the group.

In accordance with some aspects, the use parameters specify that a first data rate is used during a first period of time, and further specify that a second data rate is used during a second period of time.

In accordance with some aspects, the use parameters specify that a first data rate is used for a first type of content, and further specify that a second data rate is used for a second type of content.

In accordance with some aspects, the use parameters specify that a first data rate is used until a first percentage of the amount of data is used, and further specify that a second data rate is used for after the first percentage of the amount of data is used.

In accordance with some aspects, the method(s) and processor(s) or other means may further or alternatively: cause one of (1) the amount of time units, (2) the amount of messages, and (3) the amount of data to be increased or decreased based on behavior of the first user.

In accordance with some aspects, the method(s) and processor(s) or other means may further or alternatively: detect whether the first user is participating in a ride-share program; cause the one of (1) the amount of time units, (2) the amount of messages, and (3) the amount of data to be changed in one way when the first user is participating in the ride-share program; and cause the one of (1) the amount of time units, (2) the amount of messages, and (3) the amount of data to be changed in another way when the second user is not participating in the ride-share program.

In accordance with some aspects, the method(s) and processor(s) or other means may further or alternatively: detect whether the first user has purchased a qualified product; cause the one of (1) the amount of time units, (2) the amount of messages, and (3) the amount of data to be changed in one way when the first user has purchased the qualified product; and cause the one of (1) the amount of time units, (2) the amount of messages, and (3) the amount of data to be changed in another way when the first user has not purchased the qualified product.

In accordance with some aspects, one or more of the allocations of the service for the group and the users are automatically determined based on one or more characteristics of one or more of the users.

In accordance with some aspects, the one or more characteristics include a gender, an age, and an occupation or position, and optionally a location of the one or more users.

In accordance with some aspects, the amounts of time units, messages and data are set by one or more of the users.

In accordance with some aspects, the portions are set by one or more of the users.

In accordance with some aspects, the method(s) and processor(s) or other means may further or alternatively: receive additional data that specifies the payment amount, wherein the allocation of the services for the group is based on the payment amount.

In accordance with some aspects, the modification causes an increase or decrease to a first one of (1) the amount of time units, (2) the amount of messages, (3) the amount of data, and (4) the first portion, and wherein the adjustment causes a respective decrease or increase to a second one of (1) the payment amount, (2) the amount of time units, (3) the amount of messages, (4) the amount of data, (5) the second portion, and (6) the third portion.

In accordance with some aspects, the method(s) and processor(s) or other means may further or alternatively: receive one or more use parameters from a first computing device operated by a first one of the users, wherein the use parameters specify that a second computing device operated by a second one of the users cannot transmit phone calls, text messages, or data during a first time period on a particular day; and generate executable instructions that, when executed by the second computing device, prevent the second computing device from transmitting the phone calls, text messages, or data during the first time period on the particular day.

In accordance with some aspects, the method(s) and processor(s) or other means may further or alternatively: generate executable instructions that, when executed by a processor, cause a screen to display graphical representations of the allocations to a user.

In accordance with some aspects, the method(s) and processor(s) or other means may further or alternatively: cause a graphical user interface to display graphical representations of the allocations to a user, wherein the data that specifies the modification is based on input received from the user via the graphical user interface.

In accordance with some aspects, the system includes a network that comprises a receiver, a transmitter and a remote processing system, wherein at least one of the one or more processors are located within the remote processing system.

An output from one system may cause another system to perform a method even if intervening steps occur between the output and performance of the method.

Any method step or feature disclosed herein may be expressly restricted from a claim for various reasons like achieving reduced manufacturing costs, lower power consumption, and increased processing efficiency.

The illustrative methods described herein may be implemented, performed, or otherwise controlled by suitable hardware known or later-developed by one of ordinary skill in the art, or by firmware or software executed by processor(s), or any combination of hardware, software and firmware. Software may be downloadable and non-downloadable at a particular system. Such software comprises a machine-implemented component that, once loaded on a machine like a processor or a computer, changes the operation of that machine.

Systems on which methods described herein are performed may include one or more means that implement those methods. For example, such means may include processor(s) or other hardware that, when executing instructions (e.g., embodied in software or firmware), perform any method step disclosed herein. A processor may include, or be included within, a computer or computing device, a controller, an integrated circuit, a “chip”, a system on a chip, a server, other programmable logic devices, other circuitry, or any combination thereof.

“Memory” may be accessible by a machine (e.g., a processor), such that the machine can read/write information from/to the memory. Memory may be integral with or separate from the machine. Memory may include a non-transitory machine-readable medium having machine-readable program code (e.g., instructions) embodied therein that is adapted to be executed to implement each of the methods and method steps disclosed herein. Memory may include any available storage media, including removable, non-removable, volatile, and non-volatile media—e.g., integrated circuit media, magnetic storage media, optical storage media, or any other computer data storage media. As used herein, machine-readable media includes all forms of machine-readable media except to the extent that such media is deemed to be non-statutory (e.g., transitory propagating signals).

Application programs may carry out aspects by receiving, converting, processing, storing, retrieving, transferring and/or exporting data, which may be stored in a hierarchical, network, relational, non-relational, object-oriented, or other data source.

All of the information disclosed herein may be represented by data, and that data may be transmitted over any communication pathway using any protocol, stored on a data source, and processed by a processor. For example, information can be represented by data that is transmitted between devices and/or components using data signals or packets. Transmission of data may be carried out using a variety of wires, cables, radio signals and infrared light beams, and an even greater variety of connectors, plugs and protocols even if not shown or explicitly described. Systems/platforms described herein may exchange information with each other (and with other systems that are not described) using any known or later-developed communication technology, including WiFi, Bluetooth, NFC and other communication network technologies. Carrier waves may be used to transfer data and instructions through electronic, optical, air, electromagnetic, radio frequency, or other signaling media over a network using network transfer protocols, including data that is transferred in data signals. Data, instructions, commands, information, signals, bits, symbols, and chips disclosed herein may be represented by voltages, currents, electromagnetic waves, magnetic fields or particles, optical fields or particles, or any combination thereof.

Different systems/platforms disclosed herein may be geographically dispersed from one another in different regions (e.g., cities, countries), such that different method steps are performed in different regions and by different systems/platforms.

Features in system figures that are illustrated as rectangles may refer to hardware, firmware or software, each of which may comprise a component of a device. It is noted that lines linking two such features may be illustrative of data transfer between those features. Such transfer may occur directly between those features or through intermediate features even if not illustrated. Where no line connects two features, transfer of data between those features is contemplated unless otherwise stated. Thus, such lines are provided to illustrate certain aspects, but should not be interpreted as limiting. The words comprise, comprising, include, including and the like are to be construed in an inclusive sense (i.e., not limited to) as opposed to an exclusive sense (i.e., consisting only of). Words using the singular or plural number also include the plural or singular number, respectively. The words or or and, as used in the Detailed Description, cover any of the items and all of the items in a list. The words some, any and at least one refer to one or more. The term may is used herein to indicate an example, not a requirement—e.g., a thing that may perform an operation or may have a characteristic need not perform that operation or have that characteristic in each embodiment, but that thing performs that operation or has that characteristic in at least one embodiment. This disclosure is not intended to be limited to the aspects shown herein but is to be accorded the widest scope understood by a skilled artisan, including equivalents.

### RELATED APPLICATIONS

This application relates and claims priority to U.S. Patent Application Ser. No. 61/896,045, filed Oct. 26, 2013, entitled SYSTEMS AND METHODS FOR CREATING AND MANAGING MOBILE PHONE SERVICES, the content of which is hereby incorporated by reference herein in its entirety.

This application relates and claims priority to U.S. Patent Application Ser. No. 61/905,738, filed Nov. 18, 2013, entitled SYSTEMS AND METHODS FOR CREATING AND MANAGING MOBILE PHONE SERVICES, the content of which is hereby incorporated by reference herein in its entirety.

This application relates and claims priority to U.S. Patent Application Ser. No. 61/939,682, filed Feb. 13, 2014, entitled SYSTEMS AND METHODS FOR CREATING AND MANAGING MOBILE PHONE SERVICES, the content of which is hereby incorporated by reference herein in its entirety.

1. A method for allocating mobile services to a group of subscribers, the method comprising:
generating, using one more processors, an allocation of services for a group of subscribers that specifies an amount of time units for a phone call service, an amount of messages for a text messaging service, and an amount of data for a data service;
generating, using the one more processors, a respective allocation of the services for each of the subscribers that specifies respective portions of the amount of the time units, the amount of the messages, and the amount of the data for that subscriber;
receiving data that specifies a modification to (1) the amount of time units, (2) the amount of messages, (3) the amount of data, or (4) a first portion of a first one of the services allocated to a first subscriber;
identifying one or more locked statuses indicating whether one or more of the following can be adjusted: (1) a payment amount set by one of the subscribers, (2) the amount of time units, (3) the amount of messages, (4) the amount of data, (5) the first portion; and (6) a second portion of a second one of the services allocated to the first subscriber, or of the first one of the services allocated to a second subscriber; and
generating, based on the modification and the one or more locked statuses, one or more adjustments to one or more of (1) the payment amount, (2) the amount of time units, (3) the amount of messages, (4) the amount of data, (5) the first portion, and (6) the second portion.

2. The method of claim 1, wherein the one or more locked statuses include a locked status indicating that the payment amount set by one of the subscribers cannot be adjusted.

3. The method of claim 2, wherein the modification is to a first one of (1) the amount of time units, (2) the amount of messages, and (3) the amount of data, and wherein the one or more adjustments include an automatic adjustment to a second one of (1) the amount of time units, (2) the amount of messages, and (3) the amount of data.

4. The method of claim 3, wherein the method further comprises:
determining whether a third one of (1) the amount of time units, (2) the amount of messages, and (3) the amount of data can be adjusted based on the one or more locked statuses; and
generating the adjustment to the second one of (1) the amount of time units, (2) the amount of messages, and (3) the amount of data after determining that the third amount cannot be adjusted.

5. The method of claim 2, wherein the modification is to the first portion, and wherein the one or more adjustments include an automatic adjustment to the second portion, wherein the first portion and the second portion are allocated to the first subscriber.

6. The method of claim 2, wherein the modification is to the first portion, wherein the one or more adjustments include an automatic adjustment to the second portion, which is allocated to the second subscriber.

7. The method of claim 1, wherein the one or more locked statuses include a locked status indicating that a first one of (1) the amount of time units, (2) the amount of messages, and (3) the amount of data cannot be adjusted.

8. The method of claim 7, wherein the modification is to a second one of (1) the amount of time units, (2) the amount of messages, and (3) the amount of data, and wherein the one or more adjustments include an automatic adjustment to a third one of (1) the amount of time units, (2) the amount of messages, and (3) the amount of data.

9. The method of claim 7, wherein the modification is to the first portion, and wherein the one or more adjustments include an automatic adjustment to the second portion.

10. The method of claim 1, wherein the one or more locked statuses include a locked status indicating that the first portion cannot be adjusted.

11. The method of claim 10, wherein the second portion is allocated to the second subscriber, wherein the modification is to the first portion, and wherein the one or more adjustments include an automatic adjustment to a third portion of a third one of the services allocated to the first subscriber.

12. The method of claim 1, wherein the method further comprises:
identifying data that specifies one or more use parameters associated with the first subscriber; and
preventing the first subscriber from accessing one of the services based on the one or more use parameters

13. The method of claim 12, wherein the use parameters specify that a first subscriber cannot use one of (1) the phone call service, (2) the text messaging service, and (3) the data service during a first time period on a particular day, or at a first location.

14. The method of claim 12, wherein the use parameters specify that a first data rate is used by the first subscriber during a first period of time, and further specify that a second data rate is used by the first subscriber during a second period of time.

15. The method of claim 12, wherein the use parameters specify that a first data rate is used for a first type of content, and further specify that a second data rate is used for a second type of content

16. The method of claim 12, wherein the use parameters specify that a first data rate is used until a first percentage of the amount of data is used, and further specify that a second data rate is used after the first percentage of the amount of data is used.

17. The method of claim 1, wherein the modification causes an increase or decrease to a first one of (1) the amount of time units, (2) the amount of messages, (3) the amount of data, and (4) the first portion, and wherein the adjustment causes a respective decrease or increase to a second one of (1) the payment amount, (2) the amount of time units, (3) the amount of messages, (4) the amount of data, (5) the first portion, and (6) the second portion.

18. The method of claim 1, wherein the method further comprises:
receiving one or more use parameters from a first computing device operated by a first one of the subscribers, wherein the use parameters specify that a second computing device operated by a second one of the subscribers cannot transmit phone calls, text messages, or data during a first time period on a particular day; and
generating executable instructions that, when executed by the second computing device, prevent the second computing device from transmitting the phone calls, text messages, or data during the first time period on the particular day.

19. The method of claim 1, wherein the method further comprises:
generating executable instructions that, when executed by a processor, cause a screen to display graphical representations of the allocations to a subscriber.

20. The method of claim 1, wherein the method further comprises:
causing a graphical user interface to display graphical representations of the allocations to a subscriber, wherein the data that specifies the modification is based on input received from the subscriber via the graphical user interface.
